(19) United States
(12) Patent Application Publication
(10) Pub. No.: US 2007/0156952 A1
(43) Pub. Date: Jul. 5, 2007

(54) Digital storage safe

(76) Inventor: Heather D. Monigan, Scottsdale, AZ (US)

Correspondence Address: INTEL CORPORATION;c/o INTELLEVATE, LLC, P.O. BOX 52050, MINNEAPOLIS, MN, 55402, US

(21) Appl. No.: 11/322,904

(22) Filed: Dec. 29, 2005

(51) Int. Cl. G06F 13/28

(52) U.S. Cl. 711/112

(57) ABSTRACT

In some embodiments a digital storage safe includes a storage device, a disaster resistant container enclosing the storage device, and a connector that may be coupled to a device external to the disaster resistant container to allow the external device to read contents from the storage device and to write contents to the storage device while the storage device is enclosed in the disaster resistant container. Other embodiments are described and claimed.

### TECHNICAL FIELD

The inventions generally relate to a digital storage safe.

### BACKGROUND

In an emergency, many people will attempt to grab the family photo album before heading out the door. However, in our digital age more and more paper albums are being replaced by digital photographs and movies of irreplaceable precious family moments. Many individuals store important pictures, videos, and/or financial information on their computers and/or on backup storage devices. Similarly, many small businesses store critical information for running the business on their computers and/or backup storage devices. In the wake of Hurricane Katrina in 2005 thousands of households and small businesses have been sending their flooded hard drives to‘drive savers’to try to recover their data. In these families and small businesses even if a Network Attached Storage (NAS) box and/or an external backup hard drive device were used, having a backup of data wouldn't have helped these victims due to the severity of damage caused by flooding and fire associated with the hurricane.

Some large companies keep backup copies of electronic data at offsite locations. However, this solution is not typically satisfactory to small businesses and individuals for a number of reasons. Therefore, a simple and/or inexpensive way of backing up and accessing personal and small business data is needed to protect the data from disasters and catastrophes such as, for example, floods, fires, hurricanes, earthquakes, tornados, etc.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a digital storage safe according to some embodiments of the inventions.

FIG. 2 illustrates a block diagram of a digital storage safe according to some embodiments of the inventions.

FIG. 3 illustrates a system according to some embodiments of the inventions.

### DETAILED DESCRIPTION

Some embodiments of the inventions relate to a digital storage safe.

In some embodiments a digital storage safe includes a storage device, a disaster resistant container enclosing the storage device, and a connector that may be coupled to a device external to the disaster resistant container to allow the external device to read contents from the storage device and to write contents to the storage device while the storage device is enclosed in the disaster resistant container.

In some embodiments a system includes a digital storage safe, a computer, and an interconnect. The digital storage safe includes a storage device and a disaster resistant container enclosing the storage device. The interconnect couples the computer to the digital storage safe and allows the computer to read contents from the storage device and to write contents to the storage device while the storage device is enclosed in the disaster resistant container.

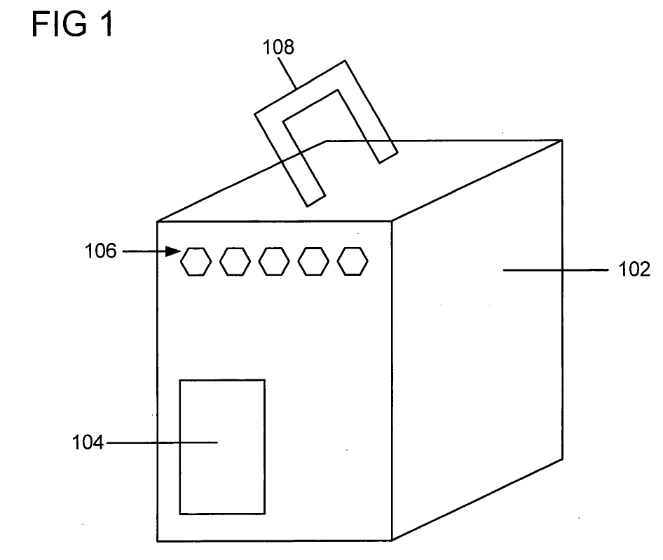

FIG. 1 illustrates a digital storage safe 100 according to some embodiments. Digital storage safe 100 includes a disaster resistant container 102, a connection panel 104, a plurality of status indicators 106, and a handle 108 (for example, an easy to grip handle). Digital storage safe also includes a storage device (not illustrated in FIG. 1) that is contained within the disaster resistant container 102.

According to some embodiments disaster resistant container 102 is fire resistant, fireproof, water resistant, waterproof, liquid resistant, liquid proof, crush proof, and/or semi-crush proof. According to some embodiments disaster resistant container 102 is made partially of or entirely of reinforced steel. According to some embodiments the outside of disaster resistant container 102 is a bright color (for example, orange, yellow, pink, and/or some other bright color). According to some embodiments the outside of disaster resistant container 102 includes a light reflecting material. According to some embodiments a reflective tape material is stuck to the outside of disaster resistant container 102. According to some embodiments a bright color and/or a light reflective material (for example, light reflective tape) is included on the outside of disaster resistant container 102 to ease in a recovery process if the digital storage safe 100 experiences some type of disaster.

According to some embodiments connector panel 104 includes a connector for one or more of a power cord connector to connect to an external power source, an Ethernet connection (for example, a Gigabit Ethernet connection, a 10 and/or 100 Mbps connection, etc.), a Fibre Channel connection, a Universal Serial Bus (USB) connection, a Serial Attached Small Computer System Interface (Serial Attached SCSI or SAS) connection, a Serial Advanced Technology Attachment (Serial ATA or SATA) connection, and/or a FireWire connection (IEEE 1394), etc. According to some embodiments connector panel 104 can take some damage (for example, from a disaster experienced by the digital storage safe 100) without any storage device or devices (for example, one or more hard disk drives) inside the disaster resistant container 102 being exposed. According to some embodiments, connector panel 104 includes a sliding door that slides down to cover and further to protect the connectors and/or any devices internal to the disaster resistant container 102 from a disaster. According to some embodiments connector panel 104 can take some damage without any exposure to a disaster of the storage device or devices and/or any other device or devices within the disaster resistant container 102.

According to some embodiments a connector panel 104 is not necessary. For example, according to some embodiments a wireless interconnect device such as a WiFi or a WiMax interface is included within the disaster resistant container 102 to help transfer data wirelessly between a storage device (or devices) within the disaster resistant container 102 and a device external to the disaster resistant container 102 (for example, the external device could be a personal computer or a computer network that writes data to and reads data from the storage device or devices). According to some embodiments, an internal cooling device such as an air conditioning unit, a liquid cooling unit (for example, a water cooling unit or a liquid convection cooling unit), and/or a cooling slab (for example, a cooling slab on a printed circuit board located within the disaster resistant container 102) may be used. According to some embodiments, no external power is required for the digital storage safe 100. For example, a battery or a super cap may be included within the disaster resistant container.

According to some embodiments status indicators 106 can be provided for example, with different colored lights, status LEDs (light emitting diodes), and/or with glass or some other protective measure covering the status indicator, etc. According to some embodiments no status indicators 106 are necessary. Although five status indicators 106 are illustrated in FIG. 1, any number of status indicators may be used according to some embodiments.

According to some embodiments, handle 108 is attached to the external side of disaster resistant container 102 (for example, to provide easy grip, portability, and/or handling of the digital storage safe 100).

According to some embodiments data may be written on and read from one or more storage devices included within disaster resistant container 102 by a device external to disaster resistant container 102 (for example, a personal computer and/or a computer network).

According to some embodiments digital storage safe 100 provides a combination of the disaster resistant container 102 and one or more storage devices contained therein such that the disaster resistant container 102 protects the data stored on the storage device (or devices) and protects any additional circuitry internal to the disaster resistant container 102, while allowing proper cooling of the inside of the disaster resistant container 102 and proper connectivity with the storage device (or devices).

According to some embodiments digital storage safe 100 provides a simple way of backing up, storing, and/or reading data while protecting the data from disasters such as, for example, floods, fires, hurricanes, earthquakes, and/or tornados.

According to some embodiments digital storage safe 100 provides a secure digital storage box that is easy to use by a household user and/or a small business and/or is also portable. According to some embodiments digital storage safe 100 acts as a storage device and protects data stored on the storage device from most natural and/or human-made disasters. According to some embodiments a user has an added sense of security that his or her data can survive a disaster such as a flood or a fire.

According to some embodiments disaster resistant container 102 has a lock thereon to lock and unlock the container. According to some embodiments the lock is a combination lock and/or a key lock.

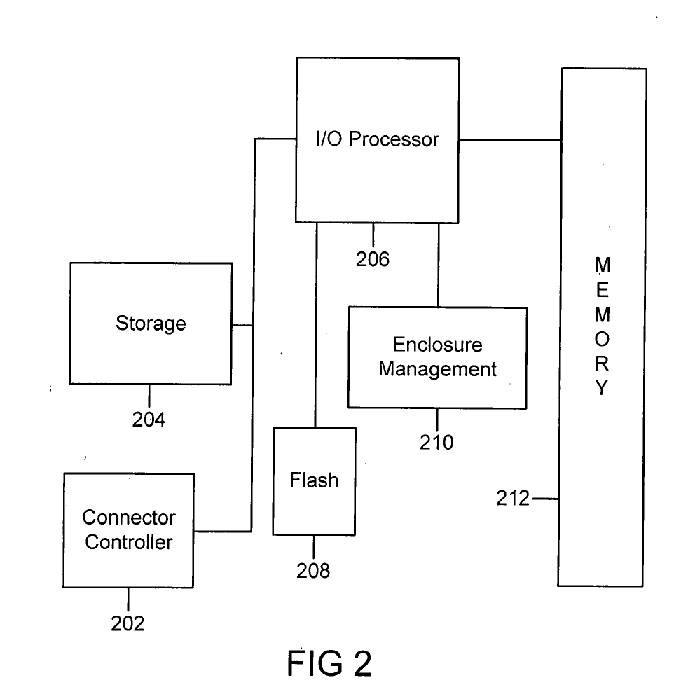

FIG. 2 illustrates a block diagram of a digital storage safe 200 according to some embodiments of the inventions. Digital storage safe 200 includes a connector controller 202, storage 204, Input/Output (I/O) processor 206, flash 208, enclosure management 210, and memory 212. According to some embodiments, connector controller 202, storage 204, Input/Output (I/O) processor 206, flash 208, enclosure management 210, and/or memory 212 are included on a Network Attached Storage (NAS) card. According to some embodiments storage 204 includes two or more hard disk drives with mirroring and/or Redundant Arrays of Independent Disks (RAID) capabilities. According to some embodiments data may be stored within storage 204 with failover and/or battery backed dynamic memory for transient data capture. According to some embodiments digital storage safe 200 is the same as or similar to digital storage safe 100 illustrated in FIG. 1, and/or connector controller 202, storage 204, Input/Output (I/O) processor 206, flash 208, enclosure management 210, and/or memory 212 is included within disaster resistant container 102 illustrated in FIG. 1.

According to some embodiments connector controller 202 is an Ethernet controller, a Gigabit Ethernet controller, a Network Interface Card (NIC), a 10/100 NIC, a Fibre Channel controller, a Universal Serial Bus (USB) controller, a Serial Attached Small Computer System Interface (Serial Attached SCSI or SAS) controller, a Serial Advanced Technology Attachment (Serial ATA or SATA) controller, a FireWire (IEEE 1394) controller, a wireless controller, a WiFi controller, a WiMax controller, and/or any other type of connector controller. According to some embodiments connector controller 202 helps couple one or more storage devices of the digital storage safe 200 to an external data transmission device or cable, for example, to enhance the writing of data to and reading of data from the storage device or devices externally from the digital storage safe 200.

According to some embodiments storage 204 includes one or more storage devices (for example, one or more hard disk drives, one or more SATA hard disk drives, small form factor disk drives such as notebook disk drives, flash memory devices, Random Access Memory (RAM) devices, solid state memory devices, stacked arrays of memory chips, non-volatile (NV) memory devices, NVRAM devices, optical disks, tape devices, and/or some other form of storage device or devices). According to some embodiments storage 204 includes one or more storage controllers (for example, one or more disk controllers, one or more RAID controllers, one or more SATA controllers, one or more memory controllers, etc.)

According to some embodiments I/O processor 206 is a general purpose processor, an Intel 80219 I/O processor, and/or a processor with X-Scale technology, etc. According to some embodiments I/O processor 206 controls input and output and runs protocols to push data to and pull data from storage 204. According to some embodiments I/O processor 206 uses firmware storage on flash memory 208 to push data to and pull data from storage 204 and to backup data on storage 204.

According to some embodiments enclosure management 210 performs functions having to do with the enclosure of the digital storage safe 200 (for example, a disaster resistant container such as disaster resistant container 102 illustrated in FIG. 1). For example, according to some embodiments enclosure management 210 performs temperature control management, cooling control, power system control such as power-up and power-down, etc.

According to some embodiments memory 212 is a battery backed memory such as a battery backed Synchronous Dynamic Random Access Memory (SDRAM). According to some embodiments memory 212 is used in situations where I/O processor 206 loses power such that power is not necessary to retain data. For example, upon a loss of power, memory 212 (for example, battery backed memory) enables I/O processor 206 to shut down properly and to get data to storage 204 from an on-board cache of the I/O processor 206.

According to some embodiments only one or some of the connector controller 202, storage 204, I/0 processor 206, flash 208, enclosure management 210, and/or memory 212 are included in digital storage safe 200.

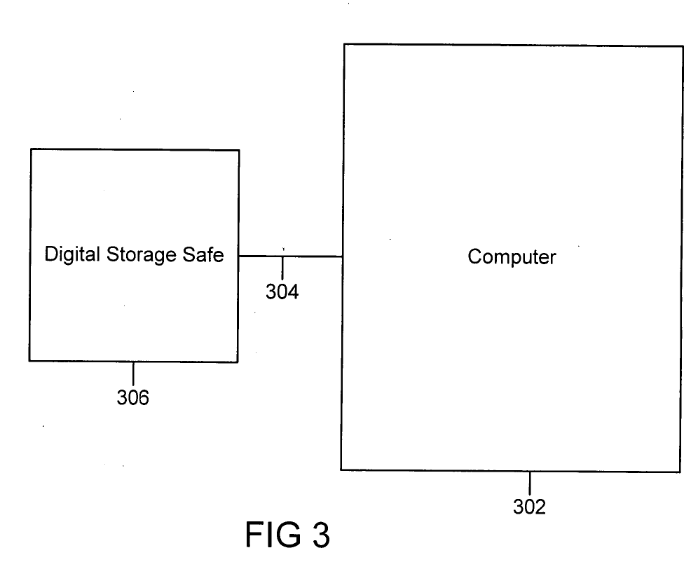

FIG. 3 illustrates a system 300 according to some embodiments. System 300 includes a computer 302, an interconnect 304, and a digital storage safe 306. According to some embodiments digital storage safe 306 includes a storage device and a disaster resistant container enclosing the storage device. According to some embodiments interconnect 304 couples the computer 302 to the digital storage safe 306, and allows the computer 302 to read contents from the storage device of the digital storage safe 306 and to write contents to the storage device of the digital storage safe 306 while the storage device is enclosed in the disaster resistant container of the digital storage safe 306. According to some embodiments digital storage safe 306 is the same as or similar to digital storage safe 100 illustrated in FIG. 1 and/or the same as or similar to digital storage safe 200 illustrated in FIG. 2. According to some embodiments interconnect 304 includes one or more of an Ethernet cable (for example, a Gigabit Ethernet cable, a 10 and/or 100 Mbps cable such as a 10/100 cable, etc.), a Fibre Channel cable, a Universal Serial Bus (USB) cable, a Serial Attached Small Computer System Interface (Serial Attached SCSI or SAS) cable, a Serial Advanced Technology Attachment (Serial ATA or SATA) cable, a FireWire cable (IEEE 1394), a wireless connection, a WiFi connection, and/or a WiMax connection, etc.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A digital storage safe comprising:
a storage device;
a disaster resistant container enclosing the storage device; and
a connector that may be coupled to a device external to the digital storage safe to allow the external device to read contents from the storage device and to write contents to the storage device while the storage device is enclosed in the disaster resistant container.

2. The digital storage safe of claim 1, wherein the disaster resistant container is at least one of fire resistant, fireproof, water resistant, and waterproof.

3. The digital storage safe of claim 1, wherein the storage device is a hard disk drive.

4. The digital storage safe of claim 1, further comprising a handle coupled to the disaster resistant container.

5. The digital storage safe of claim 1, further comprising at least one status indicator on the disaster resistant container.

6. The digital storage safe of claim 5, wherein the at least one status indicator is at least one status LED.

7. The digital storage safe of claim 1, wherein the connector includes a connector panel on the disaster resistant container to physically couple at least one interconnect to the digital storage safe.

8. The digital storage safe of claim 7, wherein the at least one interconnect includes a power cord.

9. The digital storage safe of claim 7, wherein the at least one interconnect includes an Ethernet cable.

10. The digital storage safe of claim 7, wherein the at least one interconnect includes at least one of an Ethernet cable, a Fibre Channel cable, a USB cable, an SAS cable, an SATA cable, and a FireWire cable.

11. The digital storage safe of claim 1, wherein the connector includes at least one of an Ethernet connector, a Fibre Channel connector, a USB connector, an SAS connector, an SATA connector, a FireWire connector, and a wireless connector.

12. The digital storage safe of claim 1, wherein the at least one connector is at least one of a WiFi connector and a WiMax connector.

13. The digital storage safe of claim 1, wherein the disaster resistant container includes reinforced steel.

14. The digital storage safe of claim 1, wherein the disaster resistant container includes glow-in-the-dark material.

15. The digital storage safe of claim 1, wherein the disaster resistant container is a bright color.

16. The digital storage safe of claim 1, wherein a light reflecting material is included on the disaster resistant container.

17. The digital storage safe of claim 1, further comprising a liquid cooling device inside the disaster resistant container.

18. The digital storage safe of claim 1, wherein the storage device is a least one of one or more hard disk drives, one or more flash memory, one or more non-volatile memory, one or more RAM, one or more optical disk, one or more memory chip, and one or more tape drive.

19. The digital storage safe of claim 1, wherein the disaster resistant container is resistant to at least one of a fire, a flood, a hurricane, an earthquake, and a tornado.

20. The digital storage safe of claim 1, further comprising a lock to lock the disaster resistant container shut.

21. A system comprising:
a computer;
a digital storage safe including a storage device and a disaster resistant container enclosing the storage device; and
an interconnect to electrically couple the computer to the digital storage safe and to allow the computer to read contents from the storage device and to write contents to the storage device while the storage device is enclosed in the disaster resistant container.

22. The system of claim 21, wherein the interconnect includes a network interconnect.

23. The system of claim 21, wherein the interconnect includes a wireless interconnect.

24. The system of claim 21, wherein the interconnect includes at least one of an Ethernet cable, a Fibre Channel cable, a USB cable, an SAS cable, an SATA cable, and a FireWire cable.

25. The system of claim 21, wherein the disaster resistant container is at least one of fire resistant, fireproof, water resistant, and waterproof.
